(19) United States
(12) Patent Application Publication
(10) Pub. No.: US 2009/0208861 A1
(43) Pub. Date: Aug. 20, 2009

(54) DEVELOPER AND IMAGE FORMING APPARATUS

(75) Inventor: Takahiro Nakajima, Kanagawa (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Minato-ku (JP); TOSHIBA TEC KABUSHIKI KAISHA, Shinagawa-ku (JP)

(21) Appl. No.: 12/372,005

(22) Filed: Feb. 17, 2009

Related U.S. Application Data
(60) Provisional application No. 61/029,867, filed on Feb. 19, 2008.

(51) Int. Cl. G03G 9/00; G03G 15/08

(52) U.S. Cl. 430/108.4; 399/252

(57) ABSTRACT

A developer used in an image forming apparatus contains a binder resin containing a polyester resin, a releasing agent containing natural ester wax (A) and synthetic ester wax (B), and a colorant.

### CROSS-REFERENCE TO RELATED APPLICATION

This application is based upon and claims the benefit of priority from the prior U.S. Patent Application No. 61/029,867 filed on Feb. 19, 2008, the entire contents of which are incorporated herein by reference.

### TECHNICAL FIELD

The present invention relates to a developer and an image forming apparatus used upon forming an image by an electrophotographic system, such as a duplicator and a printer.

### BACKGROUND

In an image forming apparatus using an electrophotographic system, in general, a toner is transported with an electrostatic latent image holding member, such as a photoconductive drum, a transporting medium including an intermediate transfer medium, such as an intermediate transfer belt, and is attached to a desired position of a transfer medium, such as paper. The toner is then fixed to the transfer medium by pressing with a heat roller or the like, thereby forming an image on the transfer medium.

In recent years, there are demands of speeding up of output print (high speed fixing) and saving of energy (low temperature fixing) in an image forming apparatus, and according thereto, there are studies on improvement in fixing offset property of a toner to a transfer medium (ensuring a non-offset temperature range). For the improvement in fixing offset property of a toner, it is necessary to design the toner to decrease, as much as possible, the temperature causing the low-temperature offset phenomenon, in which the toner that is not melted due to insufficient heat applied contaminates a member in contact therewith. Furthermore, it is also necessary to design the toner to increase, as much as possible, the temperature causing the high temperature offset phenomenon, in which the toner viscosity (internal cohesive force) is lowered due to excessive heat applied.

Such techniques are known for improving the fixing offset property of a toner that the thermal characteristics of the binder resin is optimized, and wax as a releasing agent is added to the toner in an amount of several percents. As measures for improving the offset property on the low temperature side by means of the binder resin, it is generally known that the glass transition temperature or the softening point temperature of the binder resin is decreased. However, too low a glass transition temperature deteriorates the storage characteristics of the toner at a high temperature to lower the fluidity of the toner, and thus there is a limit in decreasing the glass transition temperature, which yields difficulty in significant improvement of the offset property on the low temperature side.

Since the offset occurring temperature on the high temperature side is simultaneously lowered thereby, olefin wax or ester wax is used as a releasing agent to prevent the offset property on the high temperature side from being deteriorated.

For example, JP-A-49-65231, JP-A-58-16250, JP-A-50-27546, JP-A-55-153944 and the like propose a method of having polyolefin wax, such as low molecular weight polypropylene and low molecular weight polyethylene, in a toner, and JP-A-7-98511 proposes the use of a polyfunctional polyester compound having a tertiary or quaternary carbon atom and being obtained from a bifunctional or higher functional alcohol compound or carboxylic acid compound.

These kinds of wax are different from each other in compatibility with binder resins. Olefin wax has good compatibility with a styrene-acrylic resin but has poor compatibility with a polyester resin, and therefore, in general, olefin wax is frequently used with a styrene-acrylic resin. Ester wax has good compatibility with a polyester resin but has poor compatibility with a styrene-acrylic resin, and therefore, in general, ester wax is frequently used with a polyester resin.

It is effective to use natural ester wax with a polyester resin, which is advantageous for low temperature fixing, since it is good in compatibility as compared to olefin wax. However, sufficient improvement is difficultly obtained with natural ester wax solely, and the offset property on the high temperature side is also difficultly improved.

The ester wax also includes synthetic ester wax, which is obtained through polymerization reaction of an acid component and an alcohol component. Synthetic ester wax, unlike natural ester wax, has a high degree of freedom in designing since the properties thereof, such as the melting point, can be varied by changing the reaction conditions on condensation reaction, and the like.

The use of synthetic ester wax provides such an effect on the offset property on the high temperature side that is equivalent to the case using natural ester wax. However, synthetic ester wax is poor in dispersibility in a toner, and exudes on the surface of the toner upon allowing to stand at a high temperature, thereby deteriorating the storage characteristics of the toner. Accordingly, it is difficult to use synthetic ester wax as a releasing agent for a toner.

### SUMMARY

The invention relates to, as one aspect, a developer containing a binder resin containing a polyester resin, a releasing agent containing synthetic ester wax and natural ester wax, and a colorant.

The invention relates to, as another aspect, an image forming apparatus forming an image on a transfer medium, the apparatus containing an image holding member, on which an electrostatic latent image is formed, and the electrostatic latent image is developed with a developer to form the image, the developer containing a binder resin containing a polyester resin, a releasing agent containing synthetic ester wax and natural ester wax, and a colorant.

It is to be understood that both the foregoing general description and the following detailed description are exemplary and explanatory only and are not restrictive of the invention, as claimed.

### DESCRIPTION OF THE DRAWINGS

The accompanying drawings, which are incorporated in and constitute a part of this application, illustrate an embodiment of the invention and together with the description, serve to explain the principles of the invention.

FIG. 1 is a schematic diagram showing an image forming apparatus of a four-tandem process according to an embodiment of the invention; and

FIG. 2 is a table showing the compositions and the evaluation results of the developers of examples and comparative examples, according to an embodiment of the invention.

### DETAILED DESCRIPTION

Reference will now be made in detail to the present embodiment of the invention, an example of which is illustrated in the accompanying drawings.

A developer of the embodiment contains toner particles containing at least a polyester resin, a releasing agent containing natural ester wax (A) and synthetic ester wax (B), and a colorant.

An image forming apparatus of the embodiment is an image forming apparatus forming an image on a transfer medium, the apparatus contains an image holding member, on which an electrostatic latent image is formed, and the electrostatic latent image is developed with a developer to form the image, and the developer contains at least a binder resin containing a polyester resin, a releasing agent containing natural ester wax (A) and synthetic ester wax (B), and a colorant.

As the wax contained in the developer as a releasing agent, it is necessary to use both natural ester wax and synthetic ester wax in combination. The natural wax functions as not only a releasing agent but also a dispersion assistant. The use of the natural wax in combination enhances the dispersibility of the synthetic ester wax, thereby improving the storage characteristics of the developer at a high temperature.

Examples of the natural ester wax for enhancing the dispersibility of the toner, decreasing the viscosity thereof, and enhancing the releasing property thereof include candelilla wax, carnauba wax and rice wax.

The synthetic ester wax used in the embodiment can be specifically obtained through condensation reaction of a linear saturated monocarboxylic acid and a linear saturated monohydric alcohol or a dihydric to hexahydric alcohol.

Examples of the linear saturated monocarboxylic acid include myristic acid, palmitic acid, stearic acid, arachinic acid, behenic acid, lignoceric acid, cerotic acid, montanic acid and melissic acid. Examples of the linear saturated monohydric alcohol include myristyl alcohol, cetyl alcohol, stearyl alcohol, arachyl alcohol, behenyl alcohol, tetracosanol, hexacosanol, octacosanol and triacontanol. Examples of the dihydric to hexahydric alcohol include ethylene glycol, propylene glycol, neopentyl glycol, glycerin, trimethylolpropane, pentaerythritol and dipentaerythritol.

The difference between the maximum endothermic peak T_{A} of the natural ester wax (A) and the maximum endothermic peak T_{B} of the synthetic ester wax (B) (T_{A}−T_{B}=Δ° C.) is preferably in a range of −3≦Δ° C.≦19 (° C.). The difference of the maximum endothermic peaks is larger than the range, the viscosity may be increased to lower the storage characteristics, and when it is smaller than the range, the fixing offset property may be deteriorated. The difference of the maximum endothermic peaks is more preferably in a range of −1.5≦Δ° C.≦3.1 (° C.).

The maximum endothermic peak T_{A} of the natural ester wax (A) and the maximum endothermic peak T_{B} of the synthetic ester wax (B) preferably satisfy the relationship T_{A}≧T_{B}. When the relationship is T_{A}<T_{B}, the fixing offset property may be deteriorated.

The maximum endothermic peak T_{B} of the synthetic ester wax (B) is preferably in a range of 64° C.≦T_{B}≦85° C. When the maximum endothermic peak T_{B} exceeds 85° C., the fixing offset property may be deteriorated. When the maximum endothermic peak T_{B} is less than 64° C., the storage characteristics may be deteriorated. The synthetic ester wax (B) preferably has an acid value of 2 or less from the standpoint of the charge imparting property.

The mixing ratio of these kinds of wax, i.e., W_{A}/W_{B}, wherein W_{A} represents the weight of the natural ester wax (A), and W_{B} represents the weight of the synthetic ester wax (B), is preferably in a range of from 0.2≦W_{A}/W_{B}≦1.2. When the mixing ratio is less than 0.2, the dispersed state of the wax in the toner is deteriorated, and the wax exudes on the surface of the toner upon allowing to stand at a high temperature, thereby deteriorating the storage characteristics of the toner. When the mixing ratio exceeds 1.2, low temperature fixing may be difficult to be performed. The mixing ratio is preferably in a range of 0.3≦W_{A}/W_{B}≦1.0.

The addition amount of the releasing agent containing the natural ester wax (A) and the synthetic ester wax (B) is preferably from 3 to 10 parts by weight per 100 parts by weight of the binder resin from the standpoint of attaining both the offset property and the storage characteristics. When the addition amount of the releasing agent exceeds 10 parts by weight, the fluidity of the toner may be deteriorated to impair the storage characteristics at a high temperature. When the addition amount thereof is less than 3 parts by weight, the melting point Tm of the toner is increased to increase the temperature where low temperature offset occurs, and simultaneously the releasing property to a member that is in contact with the toner upon fixing is deteriorated to lower the temperature where high temperature offset occurs, thereby narrowing the non-offset temperature range.

Examples of the polyester resin that can be used include a linear polyester resin A and a crosslinked polyester resin B. Upon synthesizing the linear polyester resin A, a slight amount of a crosslinking agent may be added. The linear polyester resin A and the crosslinked polyester resin B may be used solely or as a mixture thereof.

When the linear polyester resin A and the crosslinked polyester resin B are used as a mixture, the mixing ratio (weight ratio) thereof, resin A/resin B, is preferably in a range of from 60/40 to 90/10. When the mixing ratio of the resin A is less than 60%, the temperature where low temperature offset occurs is increased, and when it exceeds 90%, the temperature where high temperature offset occurs is decreased. The ratio is more preferably in a range of from 70/30 to 85/15.

As raw material monomers for the polyester resins, a dihydric or higher alcohol component and a dibasic or higher carboxylic acid component, such as a carboxylic acid, a carboxylic anhydride and a carboxylic acid ester, are used.

Examples of the dihydric alcohol component include an alkylene oxide adduct of bisphenol A, such as polyoxypropylene(2.2)-2,2-bis(4-hydroxyphenyl)propane, polyoxypropylene(3.3)-2,2-bis(4-hydroxyphenyl)propane, polyoxypropylene(2.0)-2,2-bis(4-hydroxyphenyl)propane, polyoxypropylene(2.0)-polyoxypropylene(2.0)-2,2-bis(4-hydroxyphenyl)propane and polyoxypropylene(6)-2,2-bis(4-hydroxyphenyl)propane, ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, bisphenol A and hydrated bisphenol A.

Among these dihydric alcohol components, preferred examples thereof include a bisphenol A alkylene (having 2 or 3 carbon atoms) oxide adduct (average addition molar number: 1 to 10), ethylene glycol, propylene glycol, 1,6-hexanediol, bisphenol A and hydrated bisphenol A.

Examples of the trihydric or higher alcohol component include sorbitol, 1,2,3,6-hexanetetrol, 1,4-sorbitan, pentaerythritol, dipentaerythritol, 1,2,4-butanetriol, 1,2,5-pentanetriol, glycerol, 2-methylpropanetriol, 2-methyl-1,2,4-butanetriol, trimethylolethane, trimethylolpropane and 1,3,5-trihydroxybenzene.

Among these trihydric or higher alcohol components, preferred examples thereof include sorbitol, 1,4-sorbitan, pentaerythritol, glycerol and trimethylolpropane.

In the embodiment, the dihydric alcohol component and the trihydric or higher alcohol component may be used solely or in combination of plural kinds thereof. In particular, a bisphenol A alkylene (having 2 or 3 carbon atoms) oxide adduct (average addition molar number: 1 to 10) is preferably used as a major component.

Examples of the dibasic carboxylic acid component include maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, an alkenylsuccinic acid, such as n-dodecenylsuccinic acid, an alkylsuccinic acid, such as n-dodecylsuccinic acid, and anhydrides and lower alkyl esters of these acids.

Among these dibasic carboxylic acid, preferred examples thereof include maleic acid, fumaric acid, terephthalic acid and succinic acid substituted with an alkenyl group having from 2 to 20 carbon atoms.

Examples of the tribasic or higher carboxylic acid component include 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, trimeric acid (Empol), and anhydrides and lower alkyl esters of these acids.

Among these tribasic or higher carboxylic acids, preferred examples thereof include 1,2,4-benzenetricarboxylic acid (trimellitic acid), and an anhydride and an alkyl (having from 1 to 12 carbon atoms) ester thereof.

In the embodiment, the dibasic carboxylic acid and the tribasic or higher carboxylic acid may be used solely or in combination of plural kinds thereof. In particular, fumaric acid, terephthalic acid and succinic acid substituted with an alkenyl group having from 2 to 20 carbon atoms, which are dibasic carboxylic acid components, and 1,2,4-benzenetricarboxylic acid (trimellitic acid), and an anhydride and an alkyl (having from 1 to 12 carbon atoms) ester thereof, which are tribasic or higher carboxylic acid components, are preferably used as a major component.

Examples of the crosslinking agent added in a slight amount to the resin B or the resin A upon synthesizing the resins include a tribasic or higher acid, such as tribasic trimellitic acid, and a trihydric or higher alcohol. The use of the crosslinking agent enhances the high temperature offset property, and enhances the pulverizing property upon producing the toner by the pulverizing method described later.

Upon polymerizing the raw material monomers for the polyester resin, a catalyst that is ordinarily used may be employed, such as butyltin oxide, a titanium compound, dialkoxytin(II), tin(II) oxide, a tin(II) fatty acid, tin(II) dioctanoate and tin(II) distearate to enhance the reaction.

The polyester resin as a binder resin can be formed by using the monomers, the crosslinking agent, the catalyst and the like. When the polyester resin A and the polyester resin B are used in combination, the polyester resin A and the polyester resin B are produced separately and then mixed with each other. The mixing method is not particularly limited, and examples of the method include a method of drying the resin respectively and mixed upon producing the toner, and a method of mixing the resin before drying.

Examples of the colorant used in the embodiment include carbon black and organic and inorganic pigments and dyes that are ordinarily used in the field of a color toner. Examples of the carbon black include acetylene black, furnace black, thermal black, channel black and Ketjen black.

Examples of the pigments and dyes include Fast Yellow G, Benzidine Yellow, Indian Fast Orange, Irgazin Red, Carmine FB, Permanent Bordeaux FRR, Pigment Orange R, Lithol Red 2G, Lake Red C, Rhodamine FB, Rhodamine B Lake, Phthalocyanine Blue, Pigment Blue, Brilliant Green B, Phthalocyanine Green and quinacridone, which may be used solely or as a mixture thereof.

The addition amount of the colorant is preferably from 4 to 10 parts by weight per 100 parts by weight of the binder resin. When the addition amount of the colorant is less than 4 parts by weight, a sufficient image density may not be obtained. When the amount exceeds 10 parts by weight, an excessive pigment may be present on the surface of the toner, which is attached to the photoconductor drum to cause filming.

In the embodiment, a charge controlling agent or the like for controlling the frictional charge amount may be added. Examples of the charge controlling agent include a metal-containing azo compound, and the metal contained therein is preferably a complex compound or a complex salt of iron, cobalt or chromium, or a mixture thereof. A metal-containing salicylic acid derivative and a hydrophobic treated product of a metal oxide may also be used as the charge controlling agent, and the metal contained therein is preferably a complex compound or a complex salt of zirconium, zinc, chromium or boron, or a mixture thereof. The addition amount of the charge controlling agent is preferably from 0.5 to 2 parts by weight per 100 parts by weight of the binder resin.

In the embodiment, an external additive containing a fine particle compound is preferably added to the surface of the toner particles for stabilizing the fluidity, the charging property and the storage characteristics of the toner particles to be formed. As the fine particle external additive, a mixture containing two or more kinds of inorganic fine particle oxide having different particle diameters is preferably used. Examples of the inorganic fine particle oxide include silica, titania, alumina, strontium titanate and tin oxide. The inorganic fine particle oxide is preferably used after surface treating with a hydrophobic agent from the standpoint of enhancing the environmental stability. In addition to the inorganic fine particle oxide, resin fine particles having a diameter of 1 μm or less may be added.

The use of the toner particles provides such a developer that saves energy (low temperature fixing) and provides a wide non-offset temperature range on forming an image, and suffers less change in characteristics even though the developer is allowed to stand at a high temperature to possess an excellent storage characteristics.

The toner particles can be produced by a known method including a pulverizing method or a chemical method, such as a polymerization method. In the pulverizing method, the aforementioned raw materials including the binder resin, the releasing agent, the colorant and the like are mixed, kneaded, pulverized and then classified, to which the external additive is then added, thereby forming the toner particles.

Examples of an apparatus for mixing and dispersing the raw materials include a mixer and a kneader. Examples of the mixer include Henschel Mixer (produced by Mitsui Mining Co., Ltd.), Super Mixer (produced by Kawata MFG Co., Ltd.), Ribocorn (produced by Okawara Corporation), Nauta Mixer (produced by Pacific Machinery & Engineering Co., Ltd.) and Lödige Mixer (produced by Matsubo Corporation). Examples of the kneader include KRC Kneader (produced by Kurimoto, Ltd.), Buss Co-kneader (produced by Buss AG), Extruder Type TEM (produced by Toshiba Machine Co., Ltd.), TEX Biaxial Kneader (produced by Japan Steel Works, Ltd.), PCM Kneader (produced by Ikegai Corporation), Three-roll Mill, Mixing Roll Mill and Kneader (produced by Inoue Manufacturing Co., Ltd.), Kneadex (produced by Mitsui Mining Co., Ltd.), MS-type Pressure Kneader and Kneader-Ruder (produced by Moriyama Co., Ltd.) and Banbury Mixer (produced by Kobe Steel Co., Ltd.).

Examples of an apparatus for coarsely pulverizing the mixture include a hammer mill, a cutter mill, a jet mill, a roller mill and a ball mill. Examples of an apparatus for finely pulverizing the coarsely pulverized product include Counter Jet Mill, Micronjet and Inomizer (produced by Hosokawa Micron Co., Ltd.), IDS-type Mill and PJM Jet Pulverizer (produced by Nippon Pneumatic Mfg. Co., Ltd.), Crossjet Mill (produced by Kurimoto, Ltd.), Ulmax (produced by Nisso Engineering Co., Ltd.), SK Jet-O-Mill (produced by Seishin Enterprise Co., Ltd.), Kryptron (produced by Kawasaki Heavy Industries, Ltd.) and Turbo Mill (produced by Turbo Kogyo Co., Ltd.).

Examples of a classifier for classifying the finely pulverized product include Classiel, Micron Classifier and Spedic Classifier (produced by Seishin Enterprise Co., Ltd.), Turbo Classifier (produced by Nisshin Engineering Co., Ltd.), Micron Separator, Turboplex ATP and TSP Separator (produced by Hosokawa Micron Co., Ltd.), Elbow-Jet (produced by Nittetsu Mining Co., Ltd.), Dispersion Separator (produced by Nippon Pneumatic Mfg. Co., Ltd.) and YM Microcut (produced by Yasukawa Shoji Co., Ltd.). Examples of an apparatus for mixing the external additive include the mixers described above.

Examples of a sieve apparatus for sieving coarse particles or the like include Ultrasonic (produced by Koei Sangyo Co., Ltd.), Resona Sieve and Gyro Sifter (produced by Tokuju Corporation), Vibrasonic System (produced by Dalton Corporation), Sonicreen (produced by Sintokogyo, Ltd.), Turbo Screener (produced by Turbo Kogyo Co., Ltd.), Microshifter (produced by Makino MFG Co., Ltd.) and a circular vibration sieve.

In the polymerization method, a mixture containing the binder resin and the colorant is formed into coarse particles, which are then mixed with an aqueous medium. The resulting mixed liquid is mechanically sheared to form fine particles, which are then aggregated to form toner particles. The aggregated particles may be fused depending on necessity.

The toner particles thus formed preferably have a volume average particle diameter of from 3 to 8 μm. When the volume average particle diameter of the toner particles is less than 3 μm, the charge amount per weight may become too large upon applying a charge amount that can be controlled with the electric field to the toners, whereby an intended developed amount may not be obtained. When it exceeds 8 μm, a high definition image may be deteriorated in reproducibility and granularity. The volume average particle diameter is more preferably from 4 to 6 μm.

The toner particles may be used solely as a one-component developer, or may be used as a two-component developer with a magnetic carrier added thereto. Examples of the magnetic carrier include magnetic particles of ferrite, magnetite and iron oxide, resin particles containing the magnetic particles, and particles containing the magnetic particles having on at least a part of the surface thereof a resin coating, such as a fluorine resin, a silicone resin and an acrylic resin.

The magnetic carrier preferably has a volume average particle diameter of from 20 to 100 μm. When the volume average particle diameter of the magnetic carrier is less than 20 μm, the carrier particles are liable to be detached from a developer holding member and attached to a photoconductor drum due to the small magnetic force per one particle, and when it exceeds 100 μm, the magnetic brush formed may become too hard, whereby brush lines thereof may appear in an image formed, and the toner may be difficult to feed precisely. The volume average particle diameter of the magnetic carrier is more preferably from 30 to 60 μm.

As the image holding member (electrostatic latent image holding member) used in the image forming method and the image forming apparatus for forming an image on the transfer medium using the toner particles, a known photoconductor such as a positively charged or negatively charged organic photoconductor and an amorphous silicon photoconductor may be employed. In the photoconductor, a charge generating layer, a charge transporting layer and a protective layer may be laminated, or alternatively, a layer having a function of two or more layers of these layers may be formed. Besides, the transfer medium is a medium on which the image is formed finally, such as a paper sheet.

An image may be produced with the developer in an image forming apparatus, for example, a four-tandem electrophotographic process.

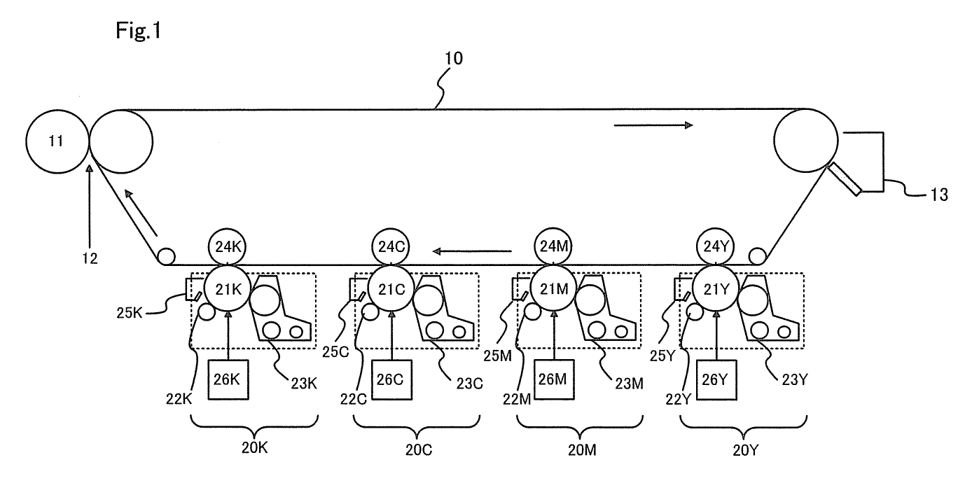

FIG. 1 is a schematic diagram showing an image forming apparatus of a four-tandem intermediate transfer process. As shown in FIG. 1, the image forming apparatus contains disposed therein image forming units 20Y, 20M, 20C and 20K each contain a developing device containing toner particles of yellow, magenta, cyan or black, a photoconductor, and charging, exposing and transferring devices. The image forming units each contain the photoconductive drum 21Y, 21M, 21C or 21K as an image holding member disposed in such a manner that the outer peripheral surface thereof is rotatable in the same direction at the position where the photoconductive drum is in contact with an intermediate transfer belt 10.

The intermediate transfer belt 10 is disposed to transport images of respective colors formed on the photoconductive drums 21Y, 21M, 21C and 21K are transported in the direction shown by the arrow in the figure with. The intermediate transfer belt 10 runs in the direction shown by the arrow at a constant speed endlessly. The image forming units 20Y, 20M, 20C and 20K are disposed in series along the transporting direction of the intermediate transfer belt 10.

Each of the photoconductive drums 21Y, 21M, 21C and 21K is connected to a drum motor, which is not shown in the figure, that rotates the photoconductive drum 21Y, 21M, 21C or 21K at a constant peripheral speed. The axis lines of the photoconductive drums 21Y, 21M, 21C and 21K each are disposed perpendicularly to the direction, in which the images are transported by the intermediate transfer belt 10. The corresponding photoconductive drums 21Y, 21M, 21C and 21K are disposed to form constant intervals with the axis lines thereof.

A charging device 22Y, 22M, 22C or 22K as a charging unit, a developing device 23Y, 23M, 23C or 23K as a developing unit, a primary transferring roller 24Y, 24M, 24C or 24K as a transferring unit, and a image holding member cleaner 25Y, 25M, 25C or 25K as a cleaning unit are disposed around each of the photoconductive drums 21Y, 21M, 21C and 21K along the rotation direction thereof.

The primary transferring rollers 24Y, 24M, 24C and 24K each are disposed at the position where the intermediate transfer belt 10 is held with the photoconductive drum 21Y, 21M, 21C or 21K, i.e., disposed inside the intermediate transfer belt 10.

Exposing devices 26Y, 26M, 26C and 26K that emit laser beams are disposed for forming electrostatic latent images formed through color separation on the outer peripheral surfaces of the photoconductive drums 21Y, 21M, 21C and 21K. The exposing devices 26Y, 26M, 26C and 26K each are disposed in such a manner that the exposure point is formed on the outer peripheral surface of the photoconductive drum 21Y, 21M, 21C or 21K between the charging device 22Y, 22M, 22C or 22K and the developing device 23Y, 23M, 23C or 23K.

A secondary transferring roller 11 is in contact with the intermediate transfer belt 10, and a transfer medium 12 is inserted between the intermediate transfer belt 10 and the secondary transferring roller 11, thereby the images are transferred from the intermediate transfer belt 10 to the transfer medium 12. In the embodiment shown in the figure, the image forming units are arranged in the order of yellow, magenta, cyan and black, but the order of colors is not limited thereto.

An image is formed by using the image forming apparatus in the following manner.

The photoconductive drum 21Y is negatively (−) charged uniformly with the charging device 22Y. The photoconductive drum 21Y thus charged is exposed according to image information with the exposing device 26Y to form an electrostatic latent image. The electrostatic latent image on the photoconductive drum 21Y is reversely developed with the developing device 23Y to form a toner image on the photoconductive drum 21Y.

A bias of the reverse polarity (+) to the charging polarity of the toner is applied to the primary transferring roller 24Y with an electric power source, which is not shown in the figure. As a result, the toner image on the photoconductive drum 21Y is primarily transferred to the transfer belt 10 through a transferring electric field formed between the photoconductive drum 21Y and the primary transferring roller 24Y. The photoconductive drum 21Y after transferring is cleaned with the image holding member cleaner 25Y and then again subjected to the charging, exposing and developing process steps.

Synchronized with the toner image formation in the image forming unit 20Y, the similar process is performed in the image forming units 20M, 20C and 20K. The toner images of magenta, cyan and black formed on the photoconductive drums of the image forming units 20M, 20C and 20K are also primarily transferred to the intermediate transfer belt 10.

The transfer medium 12 is transported from a paper cassette, which is not shown in the figure, and fed to the intermediate transfer belt 10 with aligning rollers, which are not shown in the figure, synchronized with the toner images on the intermediate transfer belt 10.

A bias of the reverse polarity (+) to the charging polarity of the toner is applied to the secondary transferring roller 11 with an electric power source, which is not shown in the figure. As a result, the toner images on the intermediate transfer belt 10 are transferred to the transfer medium 12 through a transferring electric field formed between the intermediate transfer belt 10 and the secondary transferring roller 11. A fixing device, which is not shown in the figure, is disposed for fixing the toner transferred to the transfer medium 12, and the paper is subjected to the fixing device to form a fixed image. The toner that is not completely transferred to the transfer medium 12 but partially remains on the transfer belt (toner remaining after transferring) is cleaned with a cleaner 13.

The four-tandem electrophotographic process is described as an example herein, but the invention is not limited thereto. For example, the invention may be applied to a cleanerless process using no cleaner provided.

The invention will be described specifically with reference to examples.

The softening point (Tm) of the resin is measured by a temperature increasing method (½ method). The measuring apparatus used is a constant load extruding capillary rheometer, CFT-500D, produced by Shimadzu Corporation. The measurement conditions are a specimen amount of 1.5 g, an initial temperature of 40° C., an end temperature of 200° C., a temperature increasing rate of 2.5° C. per minute, a load of 10 kgf/cm², a preheating time of 300 sec, a die hole diameter of 1 mm, and a die length of 1 mm.

The melting point of the wax and the glass transition temperature Tg of the binder resin are measured with a differential thermobalance, Thermo Plus 2, produced by Rigaku Corporation, under the measurement conditions of a specimen amount of 20 mg, alumina as a reference material, a temperature increasing rate of 10° C. per minute, and a measurement temperature of from 20 to 200° C., and the specimen heated to 200° C. is cooled to 20° C. and then again heated for measuring to provide data used. The glass transition temperature Tg is measured in such a manner that tangent lines are drawn on the low temperature side and the high temperature side of the curve appearing around 40 to 70° C., and the intersecting point of the lines is designated as the glass transition temperature Tg of the resin. The maximum endothermic peak appearing in a range higher than 60° C. is designated as the melting point of the wax.

### [Synthesis of Synthetic Ester Wax]

The carboxylic acid and the alcohol described above are used as raw materials. Polycondensation reaction is performed with the carboxylic acid in an excessive amount to the alcohol to synthesize an ester compound. The polycondensation reaction is performed in the presence of absence of a catalyst at a temperature of from 100 to 250° C., and is terminated at the time when the acid value, the hydroxyl value and the melting point of the resulting ester compound reach the prescribed values.

The excessive carboxylic acid in the ester compound is removed with an alkali aqueous solution. Examples of the alkali aqueous solution for removing the acid include an alkali metal salt, such as sodium hydroxide, potassium hydroxide, sodium carbonate, potassium carbonate and sodium hydrogencarbonate, and an ammonium salt, such as ammonium carbonate. The alkali aqueous solution for removing the acid has a concentration of from 5 to 20% by weight. The ester compound after removing the acid is recrystallized, rinsed and purified to produce wax B1 to B5 shown below.

The melting points of the wax produced are as follows.
Synthetic ester wax B1 (melting point: 79.9° C.)
Synthetic ester wax B2 (melting point: 64.1° C.)
Synthetic ester wax B3 (melting point: 84.5° C.)
Synthetic ester wax B4 (melting point: 63.0° C.)
Synthetic ester wax B5 (melting point: 86.8° C.)

### [Synthesis Example of Polyester Resin]

Raw materials are placed in a 3-L four-neck flask equipped with a reflux condenser, a water separating device, a nitrogen introducing tube, a stainless steel stirrer and a thermometer, and nitrogen is introduced therein under heating with a mantle heater. The reaction is performed while checking the softening point (Tm) measured by a ring ball method to provide a linear polyester resin A and a crosslinked polyester resin B. The raw materials and the characteristics of the linear polyester resin A and the crosslinked polyester resin B are as follows.

### [Linear Polyester Resin A]

The linear polyester resin A is produced with a propylene oxide adduct of bisphenol A (40) (the numerals in parentheses are molar numbers), an ethylene oxide adduct of bisphenol A (70), terephthalic acid (30) and fumaric acid (70) (Tg: 57.4° C., Tm: 105.0° C.).

### [Crosslinked Polyester Resin B]

The crosslinked polyester resin B is produced with a propylene oxide adduct of bisphenol A (70) (the numerals in parentheses are molar numbers), an ethylene oxide adduct of bisphenol A (25), terephthalic acid (60), a succinic acid derivative (15) and trimellitic anhydride (10) (Tg: 56.8° C., Tm: 149.6° C.).

Toner particles of Examples 1 to 14 and Comparative Examples 1 to 4 are produced by using the wax B1 to B5 and the polyester resins A and B thus obtained.

### EXAMPLE 1

The following components are mixed in the following formulation;

| | |
|---|---|
| Binder resin (resin A/resin B = 80/20) | 87 parts by weight |
| Wax A (rice wax, melting point: 82.6° C.) | 3 parts by weight |
| Wax B1 (synthetic ester wax, melting point: | 3 parts by weight |
| 79.9° C.) | |
| Colorant (MA-100) | 6 parts by weight |
| Charge controlling agent (metal-containing salicylic | 1 part by weight |
| acid derivative) | |

The aforementioned components are mixed with Henschel Mixer and kneaded with a biaxial extruder. The resulting molten and kneaded product is cooled, coarsely pulverized with a hummer mill, finely pulverized with a jet pulverizer, and classified to provide powder.

To 100 parts by weight of the powder, 1 part by weight of a monodisperse inorganic fine particles having an average primary particle diameter of 100 nm, 1 part by weight of hydrophobic silica having an average primary particle diameter of 30 nm and 0.5 part by weight of hydrophobic titanium oxide having an average primary particle diameter of 20 nm are externally added with Henschel Mixer to provide a toner. The difference of the maximum endothermic peaks of the two kinds of wax (which is hereinafter referred to as Δ° C.) is 2.7° C.

6 parts by weight of the toner is mixed with 100 parts by weight of a ferrite carrier coated with a silicone resin having an average particle diameter of 40 μm, and the mixture is agitated with a turbulence mixer to provided a developer.

The resulting developer is evaluated as follows.

### [Evaluation of Fixing Offset]

A fixing system is obtained by modifying e-studio 3510c, available from Toshiba Tec Corporation, to have a fixing process speed increased twice, with which a solid image having a toner attaching amount of 1.6 mg/cm² is printed on paper while the fixing temperature is changed from 110° C. to 200° C. with a step of 5° C., and the occurrence of offset is visually observed. The temperature, at which peel-off of the image occurs, is designated as the temperature where low-temperature offset occurs, and the temperature, at which roughness can be clearly found on the surface of the image, is designated as the temperature where high-temperature offset occurs. The temperature range where low-temperature offset and high-temperature offset do not occur is designated as the non-offset temperature range, which is evaluated as A for 35° C. or more, B for 25 or more and less than 35° C., and C for less than 25° C.

### [Toner Storage Test]

20 g of the toner is sealed in a resin container and allowed to stand in a thermostat chamber set at 55° C. for 8 hours. After taking out from the thermostat chamber, the toner is cooled by standing for 12 hours or more. The toner is sieved with a 42-mesh sieve using Powder Tester (produced by Hosokawa Micron Co., Ltd.), which is operated for 10 seconds with its dial set up as 4. The amount of the toner remaining on the sieve is measured and evaluated as A for less than 5 g and C for 5 g or more.

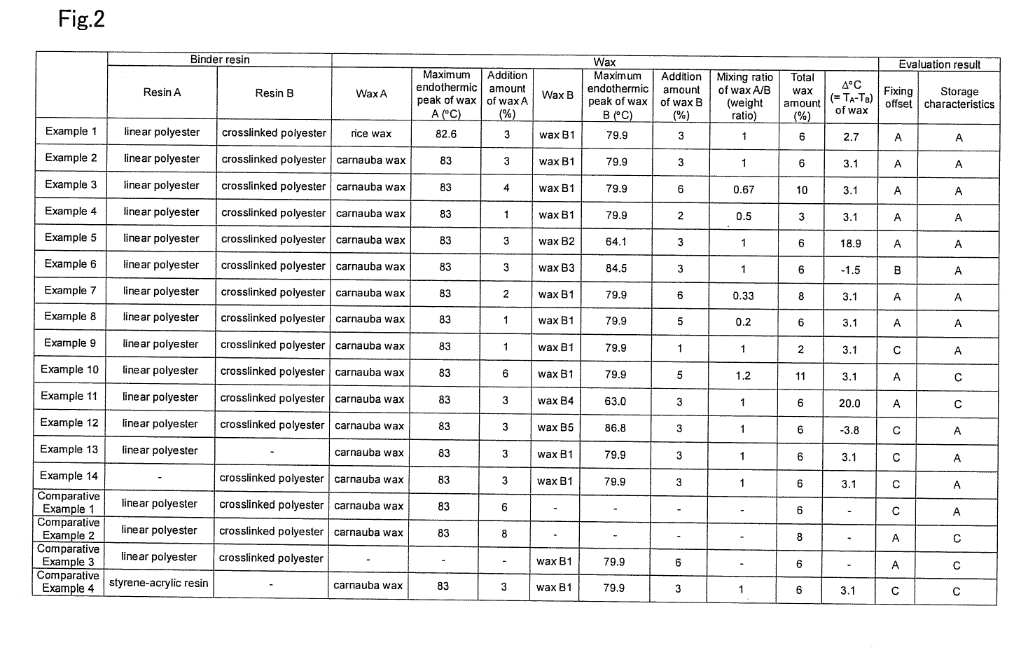

The evaluation results are shown in FIG. 2. As shown in FIG. 2, the toner has an enhanced non-offset temperature range and good storage characteristics at a high temperature.

### EXAMPLE 2

The following components are mixed in the following formulation;

| | |
|---|---|
| Binder resin (resin A/resin B = 80/20) | 87 parts by weight |
| Wax A (carnauba wax, melting point: 83.0° C.) | 3 parts by weight |
| Wax B1 (synthetic ester wax, melting point: | 3 parts by weight |
| 79.9° C.) | |
| Colorant (MA-100) | 6 parts by weight |
| Charge controlling agent (metal-containing salicylic | 1 part by weight |
| acid derivative) | |

A toner is produced with the aforementioned components in the same manner as in Example 1. Δ° C. of the two kinds of wax is 3.1° C. A developer is produced with the resulting toner in the same manner as in Example 1 and evaluated in the same manner as in Example 1. The evaluation results are shown in FIG. 2. As shown in FIG. 2, favorable results are obtained in the evaluation.

### EXAMPLE 3

The following components are mixed in the following formulation;

| | |
|---|---|
| Binder resin (resin A/resin B = 80/20) | 83 parts by weight |
| Wax A (carnauba wax, melting point: 83.0° C.) | 4 parts by weight |
| Wax B1 (synthetic ester wax, melting point: | 6 parts by weight |
| 79.9° C.) | |
| Colorant (MA-100) | 6 parts by weight |
| Charge controlling agent (metal-containing salicylic | 1 part by weight |
| acid derivative) | |

A toner is produced with the aforementioned components in the same manner as in Example 1. Δ° C. of the two kinds of wax is 3.1° C. A developer is produced with the resulting toner in the same manner as in Example 1 and evaluated in the same manner as in Example 1. The evaluation results are shown in FIG. 2. As shown in FIG. 2, favorable results are obtained in the evaluation.

### EXAMPLE 4

The following components are mixed in the following formulation;

| | |
|---|---|
| Binder resin (resin A/resin B = 80/20) | 90 parts by weight |
| Wax A (carnauba wax, melting point: 83.0° C.) | 1 part by weight |
| Wax B1 (synthetic ester wax, melting point: | 2 parts by weight |
| 79.9° C.) | |
| Colorant (MA-100) | 6 parts by weight |
| Charge controlling agent (metal-containing salicylic | 1 part by weight |
| acid derivative) | |

A toner is produced with the aforementioned components in the same manner as in Example 1. Δ° C. of the two kinds of wax is 3.1° C. A developer is produced with the resulting toner in the same manner as in Example 1 and evaluated in the same manner as in Example 1. The evaluation results are shown in FIG. 2. As shown in FIG. 2, favorable results are obtained in the evaluation.

### EXAMPLE 5

The following components are mixed in the following formulation;

| | |
|---|---|
| Binder resin (resin A/resin B = 80/20) | 87 parts by weight |
| Wax A (carnauba wax, melting point: 83.0° C.) | 3 parts by weight |
| Wax B2 (synthetic ester wax, melting point: | 3 parts by weight |
| 64.1° C.) | |
| Colorant (MA-100) | 6 parts by weight |
| Charge controlling agent (metal-containing salicylic | 1 part by weight |
| acid derivative) | |

A toner is produced with the aforementioned components in the same manner as in Example 1. Δ° C. of the two kinds of wax is 18.9° C. A developer is produced with the resulting toner in the same manner as in Example 1 and evaluated in the same manner as in Example 1. The evaluation results are shown in FIG. 2. As shown in FIG. 2, favorable results are obtained in the evaluation.

### EXAMPLE 6

The following components are mixed in the following formulation;

| | |
|---|---|
| Binder resin (resin A/resin B = 80/20) | 87 parts by weight |
| Wax A (carnauba wax, melting point: 83.0° C.) | 3 parts by weight |
| Wax B3 (synthetic ester wax, melting point: | 3 parts by weight |
| 84.5° C.) | |
| Colorant (MA-100) | 6 parts by weight |
| Charge controlling agent (metal-containing salicylic | 1 part by weight |
| acid derivative) | |

A toner is produced with the aforementioned components in the same manner as in Example 1. Δ° C. of the two kinds of wax is −1.5° C. A developer is produced with the resulting toner in the same manner as in Example 1 and evaluated in the same manner as in Example 1. The evaluation results are shown in FIG. 2. As shown in FIG. 2, the non-offset temperature range is enhanced while it is still insufficient, but favorable storage characteristics are obtained.

### EXAMPLE 7

The following components are mixed in the following formulation;

| | |
|---|---|
| Binder resin (resin A/resin B = 80/20) | 85 parts by weight |
| Wax A (carnauba wax, melting point: 83.0° C.) | 2 parts by weight |
| Wax B1 (synthetic ester wax, melting point: | 6 parts by weight |
| 79.9° C.) | |
| Colorant (MA-100) | 6 parts by weight |
| Charge controlling agent (metal-containing salicylic | 1 part by weight |
| acid derivative) | |

A toner is produced with the aforementioned components in the same manner as in Example 1. Δ° C. of the two kinds of wax is 3.1° C. A developer is produced with the resulting toner in the same manner as in Example 1 and evaluated in the same manner as in Example 1. The evaluation results are shown in FIG. 2. As shown in FIG. 2, favorable results are obtained in the evaluation.

### EXAMPLE 8

The following components are mixed in the following formulation;

| | |
|---|---|
| Binder resin (resin A/resin B = 80/20) | 87 parts by weight |
| Wax A (carnauba wax, melting point: 83.0° C.) | 1 part by weight |
| Wax B1 (synthetic ester wax, melting point: | 5 parts by weight |
| 79.9° C.) | |
| Colorant (MA-100) | 6 parts by weight |
| Charge controlling agent (metal-containing salicylic | 1 part by weight |
| acid derivative) | |

A toner is produced with the aforementioned components in the same manner as in Example 1. Δ° C. of the two kinds of wax is 3.1° C. A developer is produced with the resulting toner in the same manner as in Example 1 and evaluated in the same manner as in Example 1. The evaluation results are shown in FIG. 2. As shown in FIG. 2, favorable results are obtained in the evaluation.

### EXAMPLE 9

The following components are mixed in the following formulation;

| | |
|---|---|
| Binder resin (resin A/resin B = 80/20) | 91 parts by weight |
| Wax A (carnauba wax, melting point: 83.0° C.) | 1 part by weight |
| Wax B1 (synthetic ester wax, melting point: | 1 part by weight |
| 79.9° C.) | |
| Colorant (MA-100) | 6 parts by weight |
| Charge controlling agent (metal-containing salicylic | 1 part by weight |
| acid derivative) | |

A toner is produced with the aforementioned components in the same manner as in Example 1. Δ° C. of the two kinds of wax is 3.1° C. A developer is produced with the resulting toner in the same manner as in Example 1 and evaluated in the same manner as in Example 1. The evaluation results are shown in FIG. 2. As shown in FIG. 2, the non-offset temperature range is not enhanced, but the storage characteristics are good. It is considered that the non-offset temperature range is not enhanced because the total addition amount of the wax is too small.

### EXAMPLE 10

The following components are mixed in the following formulation;

| | |
|---|---|
| Binder resin (resin A/resin B = 80/20) | 82 parts by weight |
| Wax A (carnauba wax, melting point: 83.0° C.) | 6 parts by weight |
| Wax B1 (synthetic ester wax, melting point: | 5 parts by weight |
| 79.9° C.) | |
| Colorant (MA-100) | 6 parts by weight |
| Charge controlling agent (metal-containing salicylic | 1 part by weight |
| acid derivative) | |

A toner is produced with the aforementioned components in the same manner as in Example 1. Δ° C. of the two kinds of wax is 3.1° C. A developer is produced with the resulting toner in the same manner as in Example 1 and evaluated in the same manner as in Example 1. The evaluation results are shown in FIG. 2. As shown in FIG. 2, the non-offset temperature range is favorably enhanced while the storage characteristics are not improved. It is considered that the storage characteristics are not improved because the total addition amount of the wax is too large.

### EXAMPLE 11

The following components are mixed in the following formulation;

| | |
|---|---|
| Binder resin (resin A/resin B = 80/20) | 87 parts by weight |
| Wax A (carnauba wax, melting point: 83.0° C.) | 3 parts by weight |
| Wax B4 (synthetic ester wax, melting point: | 3 parts by weight |
| 63.0° C.) | |
| Colorant (MA-100) | 6 parts by weight |
| Charge controlling agent (metal-containing salicylic | 1 part by weight |
| acid derivative) | |

A toner is produced with the aforementioned components in the same manner as in Example 1. Δ° C. of the two kinds of wax is 20.0° C. A developer is produced with the resulting toner in the same manner as in Example 1 and evaluated in the same manner as in Example 1. The evaluation results are shown in FIG. 2. As shown in FIG. 2, the non-offset temperature range is favorably enhanced while the storage characteristics are not improved. It is considered that the storage characteristics are not improved because the melting point of the synthetic ester wax is low to provide large Δ° C. of the two kinds of wax.

### EXAMPLE 12

The following components are mixed in the following formulation;

| | |
|---|---|
| Binder resin (resin A/resin B = 80/20) | 87 parts by weight |
| Wax A (carnauba wax, melting point: 83.0° C.) | 3 parts by weight |
| Wax B5 (synthetic ester wax, melting point: | 3 parts by weight |
| 86.8° C.) | |
| Colorant (MA-100) | 6 parts by weight |
| Charge controlling agent (metal-containing salicylic | 1 part by weight |
| acid derivative) | |

A toner is produced with the aforementioned components in the same manner as in Example 1. Δ° C. of the two kinds of wax is −3.8° C. A developer is produced with the resulting toner in the same manner as in Example 1 and evaluated in the same manner as in Example 1. The evaluation results are shown in FIG. 2. As shown in FIG. 2, the non-offset temperature range is not enhanced, but the storage characteristics are improved. It is considered that the non-offset temperature range is not enhanced because the melting point of the synthetic ester wax is too high.

### EXAMPLE 13

The following components are mixed in the following formulation;

| | |
|---|---|
| Binder resin (resin A/resin B = 100/0) | 87 parts by weight |
| Wax A (carnauba wax, melting point: 83.0° C.) | 3 parts by weight |
| Wax B1 (synthetic ester wax, melting point: | 3 parts by weight |
| 79.9° C.) | |
| Colorant (MA-100) | 6 parts by weight |
| Charge controlling agent (metal-containing salicylic | 1 part by weight |
| acid derivative) | |

A toner is produced with the aforementioned components in the same manner as in Example 1. Δ° C. of the two kinds of wax is 3.1° C. A developer is produced with the resulting toner in the same manner as in Example 1 and evaluated in the same manner as in Example 1. The evaluation results are shown in FIG. 2. As shown in FIG. 2, the non-offset temperature range is not enhanced, but the storage characteristics are improved. It is considered that the non-offset temperature range is not enhanced because an image is difficult to fix at a low temperature only with the crosslinked polyester resin having high Tm, thereby impairing the low-temperature offset.

### EXAMPLE 14

The following components are mixed in the following formulation;

| | |
|---|---|
| Binder resin (resin A/resin B = 0/100) | 87 parts by weight |
| Wax A (carnauba wax, melting point: 83.0° C.) | 3 parts by weight |
| Wax B1 (synthetic ester wax, melting point: | 3 parts by weight |
| 79.9° C.) | |
| Colorant (MA-100) | 6 parts by weight |
| Charge controlling agent (metal-containing salicylic | 1 part by weight |
| acid derivative) | |

A toner is produced with the aforementioned components in the same manner as in Example 1. Δ° C. of the two kinds of wax is 3.1° C. A developer is produced with the resulting toner in the same manner as in Example 1 and evaluated in the same manner as in Example 1. The evaluation results are shown in FIG. 2. As shown in FIG. 2, the non-offset temperature range is not enhanced, but the storage characteristics are improved. It is considered that the non-offset temperature range is not enhanced because the offset resistance is not obtained only with the linear polyester resin having low Tm.

### COMPARATIVE EXAMPLE 1

The following components are mixed in the following formulation;

| | |
|---|---|
| Binder resin (resin A/resin B = 80/20) | 87 parts by weight |
| Wax A (carnauba wax, melting point: | 6 parts by weight |
| 83.0° C.) | |
| Colorant (MA-100) | 6 parts by weight |
| Charge controlling agent (metal-containing salicylic | 1 part by weight |
| acid derivative) | |

A toner is produced with the aforementioned components in the same manner as in Example 1. A developer is produced with the resulting toner in the same manner as in Example 1 and evaluated in the same manner as in Example 1. The evaluation results are shown in FIG. 2. As shown in FIG. 2, the non-offset temperature range is not enhanced because no synthetic ester is used.

### COMPARATIVE EXAMPLE 2

The following components are mixed in the following formulation;

| | |
|---|---|
| Binder resin (resin A/resin B = 80/20) | 85 parts by weight |
| Wax A (carnauba wax, melting point: 83.0° C.) | 8 parts by weight |
| Colorant (MA-100) | 6 parts by weight |
| Charge controlling agent (metal-containing salicylic | 1 part by weight |
| acid derivative) | |

A toner is produced with the aforementioned components in the same manner as in Example 1. A developer is produced with the resulting toner in the same manner as in Example 1 and evaluated in the same manner as in Example 1. The evaluation results are shown in FIG. 2. As shown in FIG. 2, it is intended to enhance the non-offset temperature range by increasing the amount of the natural ester wax but using no synthetic ester wax. However, the addition of the excessive amount of the wax brings about dispersion failure, thereby failing to provide good, storage characteristics at a high temperature.

### COMPARATIVE EXAMPLE 3

The following components are mixed in the following formulation;

| | |
|---|---|
| Binder resin (resin A/resin B = 80/20) | 87 parts by weight |
| Wax B1 (synthetic ester wax, melting point: | 6 parts by weight |
| 79.9° C.) | |
| Colorant (MA-100) | 6 parts by weight |
| Charge controlling agent (metal-containing salicylic | 1 part by weight |
| acid derivative) | |

A toner is produced with the aforementioned components in the same manner as in Example 1. A developer is produced with the resulting toner in the same manner as in Example 1 and evaluated in the same manner as in Example 1. The evaluation results are shown in FIG. 2. As shown in FIG. 2, the absence of the natural ester wax brings about dispersion failure, thereby failing to provide good storage characteristics at a high temperature.

### COMPARATIVE EXAMPLE 4

The following components are mixed in the following formulation;

| | |
|---|---|
| Binder resin (acrylic-styrene resin) | 87 parts by weight |
| Wax A (carnauba wax, melting point: 83.0° C.) | 3 parts by weight |
| Wax B1 (synthetic ester wax, melting point: | 3 parts by weight |
| 79.9° C.) | |
| Colorant (MA-100) | 6 parts by weight |
| Charge controlling agent (metal-containing salicylic | 1 part by weight |
| acid derivative) | |

A toner is produced with the aforementioned components in the same manner as in Example 1. Δ° C. of the two kinds of wax is 3.1° C. A developer is produced with the resulting toner in the same manner as in Example 1 and evaluated in the same manner as in Example 1. The evaluation results are shown in FIG. 2. As shown in FIG. 2, the use of the styrene-acrylic resin as the binder resin brings about reduction of the non-offset temperature range and dispersion failure, thereby failing to provide good storage characteristics at a high temperature.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A developer comprising:
a binder resin containing a polyester resin,
a colorant, and
a releasing agent containing natural ester wax (A) and synthetic ester wax (B).

2. The developer according to claim 1, wherein a difference between a maximum endothermic peak T_{A} of the natural ester wax (A) and a maximum endothermic peak T_{B} of the synthetic ester wax (B) (T_{A}−T_{B}=Δ° C.) is in a range of −3≦Δ° C.≦19 (° C.).

3. The developer according to claim 1, wherein a maximum endothermic peak T_{A} of the natural ester wax (A) and a maximum endothermic peak T_{B} of the synthetic ester wax (B) satisfy the relationship T_{A}≧T_{B}.

4. The developer according to claim 1, wherein a maximum endothermic peak T_{B} of the synthetic ester wax (B) is in a range of 64° C.≦T_{B}≦85° C.

5. The developer according to claim 1, wherein a total amount of the releasing agent in the developer is from 3 to 10 parts by weight per 100 parts by weight of the binder resin.

6. The developer according to claim 1, wherein a mixing ratio of the wax, W_{A}/W_{B}, wherein W_{A} represents a weight of the natural ester wax (A), and W_{B} represents a weight of the synthetic ester wax (B), is in a range of 0.2≦W_{A}/W_{B}≦1.2.

7. The developer according to claim 1, wherein the natural ester wax contains at least one of candelilla wax, carnauba wax and rice wax.

8. The developer according to claim 1, wherein the synthetic ester wax is obtained through condensation reaction of a linear saturated monocarboxylic acid and a linear saturated monohydric alcohol or a dihydric to hexahydric alcohol.

9. The developer according to claim 1, wherein the binder resin contains a linear polyester resin A and a crosslinked polyester resin B.

10. The developer according to claim 9, wherein a weight mixing ratio of the linear polyester resin A and the crosslinked polyester resin B is in a range of from 60/40 to 90/10.

11. An image forming apparatus forming an image on a transfer medium, comprising:
an image holding member forming an electrostatic latent image on the image holding member, and the electrostatic latent image being developed with a developer to form the image on the image holding member,
wherein the developer comprises a binder resin containing a polyester resin, a colorant, and a releasing agent containing natural ester wax (A) and synthetic ester wax (B).

12. The apparatus according to claim 11, wherein a difference between a maximum endothermic peak T_{A} of the natural ester wax (A) and a maximum endothermic peak T_{B} of the synthetic ester wax (B) (T_{A}−T_{B}=Δ° C.) is in a range of −3≦Δ° C.≦19 (° C.).

13. The apparatus according to claim 11, wherein a maximum endothermic peak T_{A} of the natural ester wax (A) and a maximum endothermic peak T_{B} of the synthetic ester wax (B) satisfy the relationship T_{A}≧T_{B}.

14. The apparatus according to claim 11, wherein a maximum endothermic peak T_{B} of the synthetic ester wax (B) is in a range of 64° C.≦T_{B}≦85° C.

15. The apparatus according to claim 11, wherein a total amount of the releasing agent in the developer is from 3 to 10 parts by weight per 100 parts by weight of the binder resin.

16. The apparatus according to claim 11, wherein a mixing ratio of the wax, W_{A}/W_{B}, wherein W_{A} represents a weight of the natural ester wax (A), and W_{B} represents a weight of the synthetic ester wax (B), is in a range of 0.2≦W_{A}/W_{B}≦1.2.

17. The apparatus according to claim 11, wherein the natural ester wax contains at least one of candelilla wax, carnauba wax and rice wax.

18. The apparatus according to claim 11, wherein the synthetic ester wax is obtained through condensation reaction of a linear saturated monocarboxylic acid and a linear saturated monohydric alcohol or a dihydric to hexahydric alcohol.

19. The apparatus according to claim 11, wherein the binder resin contains a linear polyester resin A and a crosslinked polyester resin B.

20. The apparatus according to claim 19, wherein a weight mixing ratio of the linear polyester resin A and the crosslinked polyester resin B is in a range of from 60/40 to 90/10.
